(19) United States
(12) Patent Application Publication
(10) Pub. No.: US 2018/0081682 A1
(43) Pub. Date: Mar. 22, 2018

(54) APPLICATION DEVELOPMENT PLATFORM

(71) Applicant: PAX COMPUTER TECHNOLOGY (SHENZHEN) CO., LTD., Shenzhen (CN)

(72) Inventors: Jiale Ren, Shenzhen (CN); Aiping Zhou, Shenzhen (CN); Xiaowei Wang, Shenzhen (CN)

(21) Appl. No.: 15/823,665

(22) Filed: Nov. 28, 2017

Related U.S. Application Data
(63) Continuation-in-part of application No. PCT/CN2016/107101, filed on Nov. 24, 2016.

(30) Foreign Application Priority Data
Jul. 18, 2016 (CN) 201610571582.8

(51) Int. Cl. G06F 8/76; G06F 8/33; G06F 8/34

(52) U.S. Cl. CPC G06F 8/76; G06F 8/34; G06F 8/33

(57) ABSTRACT

An application development platform includes a native layer, an intermediate layer, a component layer, and a template layer. By constructing the intermediate layer that encapsulates the hardware interface of the native layer, the differences between different operating systems and hardware platforms can be shielded so that in the course of application development the upper-layer application developers no longer rely on specific software operating systems or hardware platforms. By constructing the native layer, intermediate layer, component layer, and template layer, and further specifying the functions and interrelationships of these layers so as to provide a hierarchical application development platform, the upper-layer application developers can carry out the development in a layered, labor-divided, and collaborative manner, thereby improving the application development efficiency.

### CROSS-REFERENCE TO RELATED APPLICATION

This application claims priority from PCT patent application with Application No. PCT/CN2016/107101 and filed on Nov. 24, 2016. The contents of the PCT application are incorporated herein by reference in its entirety.

### TECHNICAL FIELD

This disclosure relates generally to the computer development field, and more particularly relates to an application development platform.

### BACKGROUND

Point of sale (POS) terminals have been widely used by virtue of their security, convenience, reliability, and so on. But POS applications rely heavily on hardware and software systems, such that should the hardware or the operating system change, the POS application software would need to be rewritten.

According to the typical POS application development model, application developers would deal with various functional modules involved, including for example data communications, equipment management, data packing and unpacking, data encryption and decryption, user interface design, print layout, service logic, etc., based on the system's underlying application programming interfaces (APIs).

However, the existing POS application development model has some shortcomings. On the one hand, because different POS machines may have different operating systems and hardware environments, adaptation to different operating systems and hardware environments would be required. Especially when an existing POS application needs to be migrated to a new POS model, considerable efforts and time would be required for adaptation and rewriting. Furthermore, due to the fact of too many functional modules, the application developers would not be able to focus on the services the client is most concerned about. On the other hand, the existing development mode determines that the application developers can only base on the system's underlying APIs to perform a targeted full-flow development, so multi-layer and multi-person collaborative development cannot be achieved, resulting in low development efficiency.

### SUMMARY

It is therefore an objective of the disclosure to provide an application development platform intended to solve the problem that the POS application development in the prior art relies on specific software operating systems and hardware platforms and cannot be carried out in a layered and collaborative manner.

The present application provides an application development platform, which comprises: a native layer that provides hardware interfaces corresponding to an operating system to shield the electrical properties of the underlying hardware; an intermediate layer that encapsulates the hardware interfaces provided by the native layer to shield the differences between different operating systems and hardware platforms so as to provide a basic call library for an upper-layer application; a component layer that calls the basic call library provided by the intermediate layer and encapsulates service functions to provide independent functional components for an upper-layer application; and a template layer that encapsulates relevant functional components according to the requirements of an upper-layer application to provide an application development template for the upper-layer application.

Compared with the prior art, this disclosure may have the following beneficial effects. In one respect, by constructing the intermediate layer that encapsulates the hardware interfaces of the native layer, the differences between different operating systems and hardware platforms can be shielded so that in the course of application development the upper-layer application developers no longer rely on specific software operating systems or hardware platforms. In another respect, by constructing the native layer, the intermediate layer, the component layer, and the template layer, and further specifying the functions and interrelationships of these layers thus providing a hierarchical application development platform, the upper-layer application developers can carry out the development in a layered, and collaborative manner, thereby improving the application development efficiency.

### BRIEF DESCRIPTION OF THE ACCOMPANYING DRAWINGS

FIG. 1 is a schematic diagram of an application development platform in accordance with embodiment 1 of the disclosure.

FIG. 2 is a schematic diagram of an application development platform in accordance with embodiment 2 of the disclosure.

FIG. 3 is a schematic diagram of a user interface of a parameter editing tool on the application development platform provided by embodiment 2 of the disclosure.

FIG. 4 is a schematic diagram of a user interface of an interface editing tool on the application development platform provided by embodiment 2 of the disclosure.

FIG. 5 is a schematic diagram of an editing interface of a print editing tool on the application development platform provided by embodiment 2 of the disclosure.

FIG. 6 is a schematic diagram of a compilation interface for applications and libraries on the application development platform provided by embodiment 2 of the disclosure.

### DETAILED DESCRIPTION OF ILLUSTRATIVE EMBODIMENTS

The present disclosure will now be described in further detail with reference to the accompanying drawings and embodiments, in which the objects, solutions, and advantages of the disclosure will become more apparent. It is to be understood that the specific embodiments described herein are merely illustrative of the disclosure and are not intended to limit the disclosure.

Implementations of this disclosure will now be described in further detail with reference to the accompanying drawings.

### Embodiment 1

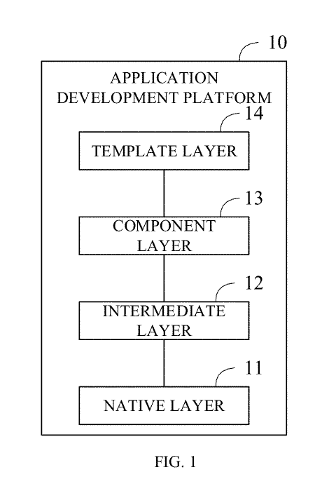

FIG. 1 shows a schematic diagram of an application development platform in accordance with embodiment 1 of the disclosure, where for purposes of illustration, only the portions relevant to the present embodiment are shown. The application development platform 10 as illustrated in FIG. 1 may comprise a native layer 11, an intermediate layer 12, a component layer 13, and a template layer 14. A detailed description of these functional modules is set forth below.

1) Native Layer 11

It is used to provide hardware interfaces corresponding to an operating system to shield the electrical properties of the underlying hardware.

In particular, the native layer 11 may be associated with particular hardware and operating system, and may provide hardware interfaces corresponding to the operating system to shield the electrical properties of the hardware.

2) Intermediate Layer 12

It is used to encapsulate the hardware interfaces provided by the native layer 11 to shield the differences between different operating systems and hardware platforms and to provide a basic call library for an upper-layer application.

In particular, due to the differences between different operating systems, the hardware interfaces provided by the corresponding native layers 11 of different operating systems will also be different, so by encapsulating the hardware interfaces provided by the native layer 11 through the intermediate layer 12, differences between different operating systems and hardware platforms can be shielded, and the upper-layer applications would not need to adapt to different operating systems and hardware platforms and thus can directly call the interface functions in the basic call library provided by the intermediate layer 12.

The basic call library is the foundation for all the upper-layer applications, and won't be arbitrarily changed unless new features or new systems are added. Therefore, the basic call library will be provided to the upper-layer application developers in the form of a program library without providing the source code.

3) Component Layer 13

It is used to call the basic call library provided by the intermediate layer 12 and encapsulate service functions to provide independent functional components for the upper-layer applications.

In particular, the component layer 13 can call the library functions in the basic call library provided by the intermediate layer 12 to encapsulate specific service functions and thus provide commonly used independent functional components for the upper-layer applications. Example functional components can include an EMV flow processing component, a communications functional component, an input functional component, etc.

The EMV flow is a financial IC (Integrated Circuit) card payment process based on EMV standard. The EMV standard is a technical standard for bank cards that was co-sponsored and created by three major international bank card organizations, including Europay (which has been acquired by MasterCard), MasterCard, and Visa. The EMV standard is an IC card based financial payment standard that has become a globally recognized uniform standard, and marks the transition from the magnetic stripe card to the smart IC card.

The functional components are provided to the upper-layer application developers in the form of source code so that for different applications they need only to perform proper adaptive modifications and adjustments on the provided functional components, thus greatly facilitating the upper-layer applications.

A complete transaction can be fulfilled by a combination of multiple separate functional components. Thus, when a new transaction is added, the transaction steps can be segmented and the separate functional components provided by the component layer 13 can be directly combined. Otherwise, if the existent functional components cannot meet the requirements, then new functional components can be added based on the default component division rules.

4) Template Layer 14

It is used to encapsulate the relevant functional components according to the requirements of an upper-layer application to provide an application development template for the upper-layer application.

In particular, customization can be provided according to the specific requirements of the upper-layer application. By encapsulating the relevant functional components, a customized application development template can be provided for the upper-layer application. This template can embrace the functions commonly used within the payment industry such as, for example, data packing and unpacking, data encryption and decryption, data collection, transactional communications, receipt printing, parameter setting, or transaction process control.

Thus, in the course of developing POS applications, the upper-layer application developers would need only to concretize the client's requirements on the basis of the application development template so that they can focus their attention on those services the client is most concerned about, thereby facilitating the application development process to be completed in a convenient and quick manner.

Meanwhile, due to the adoption of the layered architecture and the external interface provided by each layer, in the course of developing POS applications the upper-layer application developers needn't perform full-flow development on the basis of the system's underlying API, and the development can be carried out in a multi-layer and multi-person collaborative manner, improving the development efficiency.

It should be noted that, since the hierarchical architecture provided by this embodiment enables multi-layer and multi-person collaborative development, the upper-layer applications discussed in this embodiment should be understood as the applications of the various layers above the current layer. For example, the upper-layer applications of the intermediate layer 12 may be applications of the component layer 13, or may also be applications of the template layer 14; the upper-layer applications of the component layer 13 may be applications of the template layer 14; and the upper-layer applications of the template layer 14 can be POS applications the developers develop based on the development template provided by the template layer 14. In the following description of embodiments, where upper-layer applications are concerned, they will all refer to the applications of the various layers above the current layer, unless otherwise stated.

As can be seen from the application development platform illustrated in FIG. 1 above, in one respect, by constructing the intermediate layer that encapsulates the hardware interfaces of the native layer, the differences between different operating systems and hardware platforms can be shielded so that in the course of application development the developers of upper-layer applications no longer rely on specific software operating systems or hardware platforms. In another respect, by constructing the native layer, intermediate layer, component layer, and template layer, and further specifying the functions and interrelationships of these layers so as to provide a hierarchical application development platform, the upper-layer application developers can carry out the development in a layered, and collaborative manner, thereby improving the application development efficiency.

### Embodiment 2

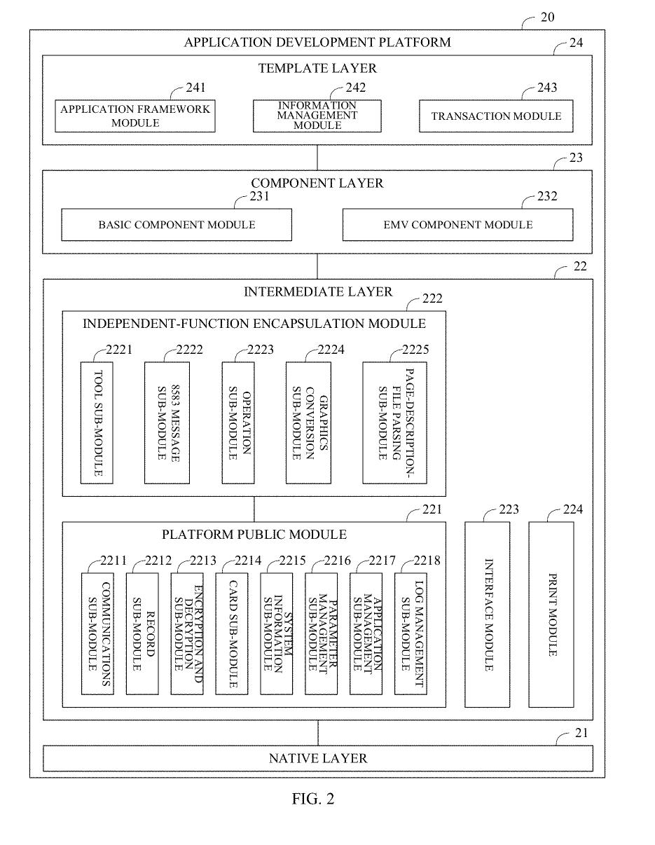

FIG. 2 shows a schematic diagram of an application development platform in accordance with embodiment 2 of the disclosure, wherein for purposes of illustration, only portions relevant to this embodiment are shown. The application development platform 20 as illustrated in FIG. 2 may comprise a native layer 21, an intermediate layer 22, a component layer 23, and a template layer 24. A detailed description of these functional modules is set forth below.

1) Native Layer 21

It is used to provide hardware interfaces corresponding to an operating system to shield the electrical properties of the underlying hardware.

In particular, the native layer 21 is associated with particular hardware and operating system, and provides hardware interfaces corresponding to the operating system to shield the electrical properties of the hardware.

2) Intermediate Layer 22

It is used to encapsulate the hardware interfaces provided by the native layer 21 to shield the differences between different operating systems and hardware platforms and to provide a basic call library for an upper-layer application.

In particular, due to the differences between different operating systems, the hardware interfaces provided by the corresponding native layers 21 of different operating systems will also be different, so by encapsulating the hardware interfaces provided by the native layer 21 through the intermediate layer 22, differences between different operating systems and hardware platform can be shielded, and the upper-layer applications need not adapt to different operating systems and hardware platforms and thus can directly call the interface functions in the basic call library provided by the intermediate layer 22.

The basic call library is the foundation for all the upper-layer applications, and won't be arbitrarily changed unless new features or new systems are added. Therefore, the basic call library will be provided to the upper-layer application developers in the form of a program library without providing the source code.

Further, the intermediate layer 22 may comprise a platform public module 221, an independent-function encapsulation module 222, an interface module 223, and a print module 224. A detailed description of these functional modules is set forth below.

a1) Platform Public Module 221

It is used to encapsulate public basic operations and thus build a public call platform.

In particular, the platform public module 221 can shield the differences in the native APIs of different operating systems and hardware platforms to enable cross-platform applications. The platform public module 221 may specifically include a communications sub-module 2211, a record sub-module 2212, an encryption/decryption sub-module 2213, a card sub-module 2214, a system information sub-module 2215, a parameter management sub-module 2216, an application management sub-module 2217, and a log management sub-module 2218. A detailed description of these sub-modules is given as follows.

a11) Communications Sub-module 2211

It is to encapsulate the communication process thus shielding the differences in the communication processes of different kinds of hardware. The upper-layer application developers may need only to handle the communication interface encapsulated by the communications sub-module without needing to heed the ways in which the Ethernet, wireless, Bluetooth, dial-up, or serial communication methods call the system functions to achieve data communications.

Further, by abstraction of the communication process, the communications sub-module 2211 can encapsulate the communication process into interfaces including, for example, opening, connecting, transmitting, receiving, closing, etc.

a12) Record Sub-module 2212

It is used to perform read and write operations on files, including the processing of various storage media and some special files such as read and write operations on a mobile storage medium, a public file, etc., as well as the synchronous write function performed on a record header and record entries of a record file.

a13) Encryption and Decryption Sub-module 2213

It is used to encapsulate encryption, decryption, and key operations, including a write key, personal identification number (PIN) retrieval, PIN entry Device (PED) operation, a generation key, a verification key, etc.

a14) Card Sub-module 2214

It is used to encapsulate the operating interfaces of bank cards, including the simplification and encapsulation of the operating interfaces of magnetic stripe cards, contact integrated circuit (IC) cards, and non-contact IC cards.

a15) System Information Sub-module 2215

It is used to encapsulate the interfaces that retrieve the basic system information, including the encapsulation of basic system information and basic system functions such as time setting, timer usage, etc.

a16) Parameter Management Sub-module 2216

It is used to store and manage parameter files. Because each upper-layer application would need a parameter file to record the associated particular parameters and parameter values of this application, the upper-layer application developers cannot change the parameters' names, and may set different read and write permissions for various parameters in the parameter file, depending on different using objects. The parameter management sub-module 2216 may use a parameter editing tool to edit or encrypt or perform other processing on the parameter file. Therefore, by encryption, the parameter file can be protected from being illegally edited and modified. FIG. 3 shows a schematic diagram of a specific user interface of a parameter editing tool.

a17) Application Management Sub-module 2217

It is used to manage, install, and uninstall the upper-layer applications, and can also be used to management the hardware equipment.

a18) Log Management Sub-module 2218

It is used to record and manage transaction logs, and the transaction logs can be divided into three levels including error, warning, and flow information. The transaction log level can be adjusted according to the actual application situation, and the transaction logs can be filtered, exported, etc., according to the set conditions.

a2) Independent-Function Encapsulation Module 222

It is used to encapsulate independent functions and basic algorithms. In particular, the independent-function encapsulation module 222 can encapsulate independent functions and basic algorithms by calling the interfaces provided by the platform public module 211.

Further, the independent-function encapsulation module 222 may specifically include a tool sub-module 2221, an 8583 message sub-module 2222, an operation sub-module 2223, a graphics conversion module 2224, and a page-description-file parsing module 2225. A detailed description as to the functions of these sub-modules is provided as follows.

a21) Tool Sub-module 2221

It is used to provide basic tool functions, such as character conversion.

a22) 8583 Message Sub-module 2222

It is used to provide ISO8583 message related functions, including setting of ISO8583 message fields' attributes, ISO8583 message packing and unpacking, etc.

The ISO8583 message (8583 packet for short), also known as 8583 message, is a packet format based on the international ISO8583 message standard, and consists of a maximum of 128 fields. Each field has a uniform specification and may have a fixed length or variable length.

a23) Operation Sub-module 2223

It is used to provide basic operation functions.

a24) Graphics Conversion Module 2224

It is used to provide picture format conversion, mainly for format conversion of electronically signed pictures.

a25) Page-description-file Parsing Sub-module 2225

It is used to provide parsing functions for page description files.

Further, the page description files can be extensible markup language (XML) files.

XML is a markup language used to mark electronic files to make them structured. XML can structuralize documents and data, and so can be exchanged between different objects, enabling creation of dynamic contents, enterprise integration, and application development.

a3) Interface Module 223

It is used to encapsulate the user interface design functions.

Further, the interface module 223 can provide a visual interface editing tool that can be used to edit an application interface, and accordingly generate a page description file corresponding to the application interface. An upper-layer application may call the library functions provided by the interface module to parse the page description file and finally present the page on the application interface.

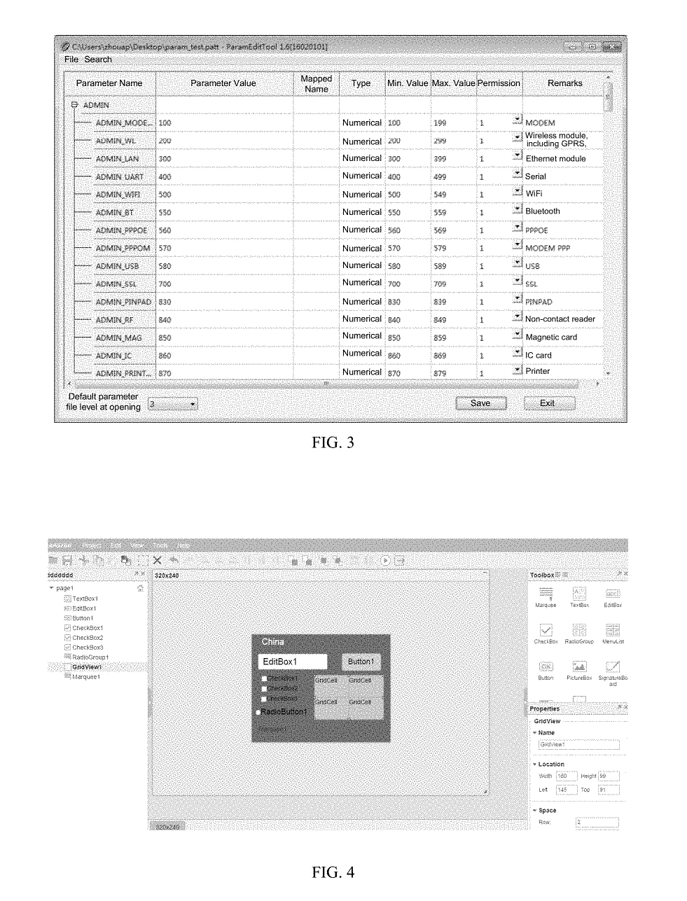

The interface module 233 can be used to edit a variety of interface controls, including Button, MenuList, TextBox, EditBox, PictureBox, SignatureBoard, CheckBox, RadioGroup, ProcessBar, Marquee, GridView, and so on. FIG. 4 shows a schematic diagram of a specific user interface of an interface editing tool.

a4) Print Module 224

It is used to encapsulate the receipt print functions.

Further, the print module 224 can provide a visual print editing tool that can be used for print and layout of a printed page, and for generation of a page description file corresponding to the printed page. An upper-layer application may call the library functions provided by the print module to parse the page description file and then directly realize the print function through a printer. FIG. 5 shows a schematic diagram of a specific editing interface of a print editing tool.

3) Component Layer 23

It is used to call the basic call library provided by the intermediate layer 22 and encapsulate service functions to provide independent functional components for the upper-layer applications.

In particular, the component layer 13 can call the library functions in the basic call library provided by the intermediate layer 22 to encapsulate specific service functions and thus provide commonly used independent functional components for the upper-layer applications. Example functional components can include an EMV flow processing component, a communications functional component, an input functional component, etc.

The EMV flow is a financial IC card payment process based on EMV standard. The EMV standard is a technical standard for bank cards that was co-sponsored and created by three major international bank card organizations, including Europay (which has been acquired by MasterCard), MasterCard, and Visa. The EMV standard is an IC card based financial payment standard that has become a globally recognized uniform standard and marks the transition from the magnetic stripe card to the smart IC card.

The functional components are provided to the upper-layer application developers in the form of source code so that for different applications they need only to perform proper adaptive modifications and adjustments on the provided functional components, thus greatly facilitating the upper-layer applications.

A complete transaction can be fulfilled by a combination of multiple separate functional components. Thus, when a new transaction is added, the transaction steps can be segmented and the separate functional components provided by the component layer 23 can be directly combined. Otherwise, if the existent functional components cannot meet the requirements, then new functional components can be added based on the default component division rules.

Further, the component layer may comprise a basic component module 231 configured for providing basic functional components (including, in particular, communications functional components of commonly used communications methods, input functional components of commonly used input methods, etc.) involved in the transaction process, and an EMV component module 232 configured for providing components involved in the EMV flow.

4) Template Layer 24

It is used to encapsulate relevant functional components according to the requirements of an upper-layer application to provide an application development template for the upper-layer application.

In particular, customization can be provided according to the specific requirements of the upper-layer application. By encapsulating the relevant functional components, a customized application development template can be provided for the upper-layer application. This template can embrace the functions commonly used within the payment industry such as, for example, data packing and unpacking, data encryption and decryption, data collection, transactional communications, receipt printing, parameter setting, or transaction process control.

Further, the template layer 24 may include: an application framework module 241 configured for constructing a framework for application initialization process and transaction process, including, in particular, application initialization, standby interface processing, standby interface loop, transaction trigger entry, management function entry, multilingual support, and so on; an information management module 242 configured for managing flow information, parameter information, personnel information, and version information of the upper-layer applications, including, in particular, flow query, parameter setting, operator management, version information management, and the like; and a transaction module 243 configured for encapsulating functional components to construct a transaction process, including, in particular, construction of various localized and customized transaction processes supported by the POS services.

Thus, in the course of developing POS applications, the upper-layer application developers would need only to concretize the client's requirements on the basis of the application development template so that they can focus their attention on those services the client is most concerned about, thereby facilitating the application development process to be completed in a convenient and quick manner.

Meanwhile, due to the adoption of the layered architecture and the external interface provided by each layer, in the course of developing POS applications the upper-layer application developers needn't perform full-flow development based on the system's underlying API, and the development can be carried out in a multi-layer and multi-person collaborative manner, improving the development efficiency.

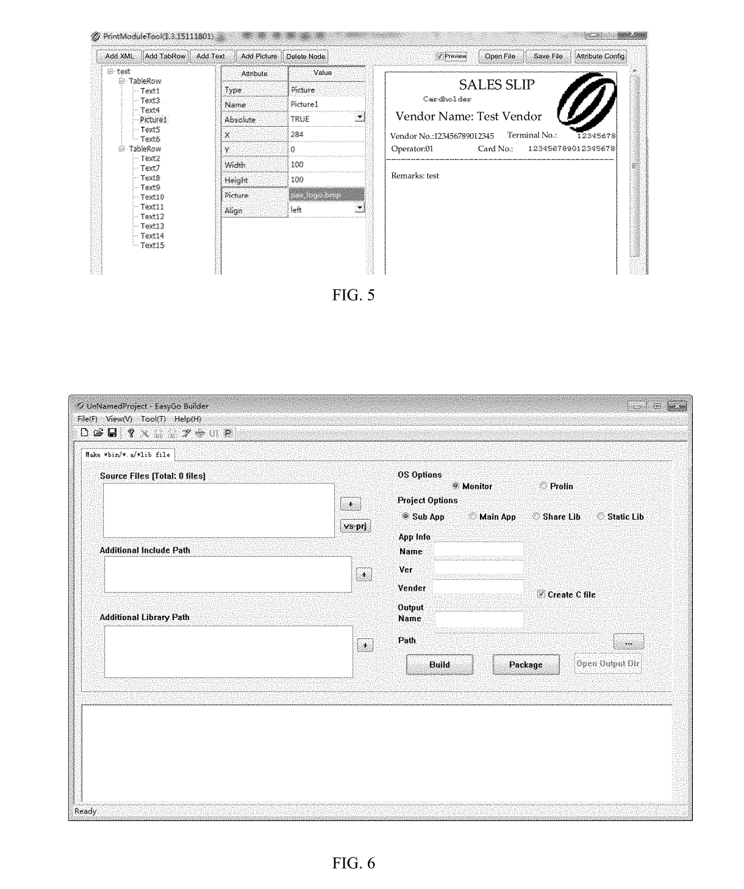

Furthermore, the application development platform according to this embodiment provides a uniform compilation environment for different operating systems, so that the corresponding operating system can be selected to compile the application programs and libraries, saving the trouble that the upper-layer application developers may need to select different compilation tools for different operating systems for compilation and thus improving the development efficiency. FIG. 6 shows a schematic diagram of a specific compilation interface for applications and libraries.

As can be seen from the application development platform illustrated in FIG. 2 above, in one respect, by constructing the intermediate layer that encapsulates the hardware interfaces of the native layer, the differences between different operating systems and hardware platforms can be shielded. By encapsulating the public basic operations through the platform's functional modules to construct the public call platform, and encapsulating the commonly used independent functions and basic algorithms through the independent-function encapsulation module to facilitate calling, and further encapsulating the receipt print functions through the print module, in the course of application development the upper-layer application developers no longer rely on specific software operating systems or hardware platforms. In another respect, by constructing the native layer, intermediate layer, component layer, and template layer, and further specifying the functions and interrelationships of these layers so as to provide a hierarchical application development platform, the upper-layer application developers can carry out the development in a layered, and collaborative manner, thereby improving the application development efficiency.

It should be noted that the various embodiments in this specification are described in a progressive manner—each embodiment focuses on its differences from other embodiments. Thus, the same or similar parts between various embodiments can be shared with one another.

It is to be noted that in the above embodiments, the various embodiments included are divided only by the functional logic, but the disclosure isn't limited to the above division, and any division that can fulfill the corresponding functions is possible. In addition, the specific names of the various functional modules are merely intended for ease of mutual distinction and thus are not intended as limiting the scope of the disclosure.

It will be understood by those of ordinary skill in the art that all or part of the steps of the various embodiments described above may be accomplished by instructing the relevant hardware via programs. The programs may be stored in a computer-readable storage medium. The storage medium may include a ROM/RAM, magnetic disk, optical disc, etc.

Furthermore, it will be apparent to those skilled in the art that this disclosure also provides an application development platform that comprises a non-transitory program storage medium and one or more processors. The non-transitory program storage medium stores program code executable by the one or more processors to perform the various methods, processes, or flows described supra. In addition, it will be apparent to those skilled in the art that various modules or sub-modules 221, 222, 223, 224, 231, 232, 241, 242, 243, 2211, 2212, 2213, 2214, 2215, 2216, 2217, 2218, 2221, 2222, 2223, 2224, and 2225 as illustrated in FIG. 2 can be software modules or sub-modules. In another aspect, it is well-known that various software modules or sub-modules inherently can be stored in the non-transitory program storage medium and executed by the one or more processors.

The foregoing description merely depicts some exemplary embodiments of the disclosure, which however are not intended to limit the disclosure. Any modifications, equivalent substitutions, or improvements made without departing from the spirit and principle of the disclosure shall all be compassed within the protection of the disclosure.

What is claimed is:

1. An application development platform, comprising one or more processors and a non-transitory program storage medium storing program codes executable by the one or more processors, the program codes comprising:
a native layer configured to provide hardware interfaces corresponding to an operating system to shield electrical properties of an underlying hardware;
an intermediate layer configured to encapsulate the hardware interfaces provided by the native layer to shield the differences between different operating systems and hardware platforms so as to provide a basic call library for an upper-layer application;
a component layer configured to call the basic call library provided by the intermediate layer to encapsulate service functions so as to provide independent functional components for an upper-layer application; and
a template layer configured to encapsulate relevant functional components according to the requirements of an upper-layer application to provide an application development template for the upper-layer application.

2. The application development platform of claim 1, wherein the intermediate layer comprises:
a platform public module configured to encapsulate public basic operations to build a public call platform;
an independent-function encapsulation module configured to encapsulate independent functions and basic algorithms;
an interface module configured to encapsulate user interface design functions; and
a print module configured to encapsulate receipt print functions.

3. The application development platform of claim 2, wherein the platform public module comprises:
a communications sub-module configured to encapsulate communication processes to shield the differences in the communication processes of different types of hardware;
a record sub-module configured to perform read and write operations on files;
an encryption and decryption module configured to encapsulate encryption, decryption, and key operations;
a card sub-module configured to encapsulate operating interfaces of bank cards;
a system information sub-module configured to encapsulate interfaces that retrieve basic system information;
a parameter management sub-module configured to store and manage parameter files;
an application management sub-module configured to manage, install, and uninstall upper-layer applications; and
a log management sub-module configured to record and manage transaction logs.

4. The application development platform of claim 3, wherein the communications sub-module is further configured to abstract the communication process and encapsulate the communication process as opening, connecting, transmitting, receiving, and closing.

5. The application development platform of claim 2, wherein the independent-function encapsulation module comprises:
a tool sub-module configured to provide basic tool functions;
an 8583 message sub-module configured to provide ISO 8583 related functions;
an operation sub-module configured to provide basic operation functions;
a graphics conversion sub-module configured to provide picture format conversion; and
a page-description-file parsing sub-module configured to provide parsing functions for page description files.

6. The application development platform of claim 2, wherein the interface module is further configured to provide a visual interface editing tool used to edit an application interface and generate a page description file corresponding to the application interface.

7. The application development platform of claim 2, wherein the print module is further configured to provide a visual print editing tool used to perform print and layout of a printed page, and generate a page description file corresponding to the printed page.

8. The application development platform of claim 5, wherein the page description files are extensible markup language (XML) files.

9. The application development platform of claim 1, wherein the component layer comprises:
a basic component module configured to provide basic functional components involved in the transaction process; and
an EMV component module configured to provide components involved in the EMV flow.

10. The application development platform of claim 1, wherein the template layer comprises:
an application framework module configured to construct a framework for an application initialization process and a transaction process;
an information management module configured to manage flow information, parameter information, personnel information, and version information of an upper-layer application; and
a transaction module configured to encapsulate the functional components to construct the transaction process.
